(19) United States
(12) Patent Application Publication
(10) Pub. No.: US 2003/0221026 A1
(43) Pub. Date: Nov. 27, 2003

(54) Automatic power saving facility for network devices

(76) Inventor: Sean Newman, Aaling (GB)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/188,537

(22) Filed: Jul. 3, 2002

(30) Foreign Application Priority Data
May 22, 2002 (GB) 0211764.6

(51) Int. Cl. G06F 3/00

(52) U.S. Cl. 710/8

(57) ABSTRACT

A network device including a port which auto-negotiates a data rate over a link also includes a traffic monitor which detects a condition denoting light traffic and causes a lower data rate to be selected for the link to reduce power consumption.

### FIELD OF THE INVENTION

This invention relates to communication networks and particularly to packet-based communication networks which include network devices such as switches and routers which communicate over respective links with other network devices and which are capable of operation at different data rates over one or more links in the network.

### BACKGROUND TO THE INVENTION

Modem network devices such as switches and routers are typically multi-port devices which can receive and forward data over a respective link to a port of a remote device. The link may be a physical link such as twisted-pair or fibre optic cable or may be a wireless link.

The design of switches and routers and other network devices has reached a considerable level of sophistication. A typical switch has a multiplicity of ports which are associated with a respective PHY (physical layer device) and a respective MAC (media access control device) by means of which receive signals are converted to a media independent format and subjected to a variety of operations such as for example de-encapsulation. The general organisation of MAC devices, PHYs and the management of a PHY by an SMI (serial management interface) is well known and need not be described in detail.

Owing to the fairly rapid technological development of communication networks, many devices are capable of operating over at least one link (and usually any link connected to an external port) at a variety of data rates, typically 10, 100 and 1000 megabits per second. This multi-rate facility enables devices to be used in both newly constructed networks operating at higher data rates or to be substituted in established networks which may employ lower data rates. Furthermore, different users may have different requirements and prefer, for a variety of reasons, to employ lower data rates rather than higher data rates.

A facility which is nowadays commonly routinely provided in physical layer devices is known as ‘auto-negotiation’. Broadly, this facility, which is usually implemented by means of a state machine in the physical layer device, is associated with a multiplicity of registers which define various characteristics of the device in respect of a link for the particular port. These characteristics or ‘parameters’ define the modes and rates of operation of which the device is capable in respect of the link. The auto-negotiation process enables the device to advertise those modes of operation to a remote device at the far end of the link and to receive corresponding advertisements from the other end of the link so that, as is defined in the process, the highest common performance parameter or set of parameters can be selected for the link. For example, and particularly pertinent to the present invention, one device may be capable of operation at 10 and 100 megabits per second over a particular link whereas a device at the far end of the link may be capable of operation at 10, 100 or 1000 megabits per second. The result of auto-negotiation in respect of speed would be to select for the link an operating speed of 100 megabits per second which is the highest common performance characteristic shared by these two devices in respect of that link.

Auto-negotiation for Ethernet networks is currently extensively defined in IEEE Standard 802.3, Chapter 28. That chapter describes in considerable detail the manner in which auto-negotiation is performed and the nature of the ‘pages’ (i.e. coded signals in the standardised format) which are exchanged between the devices to a establish communication under the process, to exchange information and to convey the result of the auto-negotiation. As indicated in the Standard, the exchanges which are part of the auto-negotiation process include ‘Next Pages’ which are partly defined by the Standard but which allow for the conveyance of user-based, i.e. selectable, information which need not be specifically related to the auto-negotiation process. One example of the use of Next Pages to convey user selectable information, particularly network topology information, is described in U.S. patent application Ser. No. 09/541,904 and in corresponding published British patent application GB-2359222-A.

### BACKGROUND TO THE INVENTION

As is indicated in the foregoing, network links are usually auto-negotiated up the highest common speed available for the link. Although in many circumstances this is advantageous, the consequence is that many networks run at a higher speed than is absolutely necessary. Consequently network products consume much more power than may be necessary. As an example, a gigabit PHY at the present time consumes 1.53 watts per port when running in gigabit mode but only 0.46 watts in 10 megabit mode, which would represent a saving of 1.07 watts (70% of the consumed power) for each port if the device ran in 10 megabit mode rather than gigabit mode. On the assumption that a network port might require a rate of more than 10 megabits for a total of one hour during any working day, the result would be 1.04 watts (a 67.9% saving) per port. If a product's main power supply is 60% efficient, there would be a mains power saving of 1.73 watts per port or 1 kilowatt in a 600 node network.

The basis of the present invention is to provide a facility which can detect when traffic related to a port of a network device is comparatively light or more generally when a maximum speed of operation is not required and to switch the link to a lower speed at least temporarily, for example while traffic is still light. More specifically, a network traffic monitor can be provided for a port so to switch or allow the network link to be switched to a lower data rate while network traffic is low and to switch or allow switching of the link to a higher rate if the volume of traffic for that port rises, particularly over a preset threshold.

The invention is intended to be used in conjunction with standard auto-negotiation which is employed to determine the data rates and (usually) the duplex capabilities for the link. The auto-negotiation process and particularly the ‘Next Page’ function may therefore be used to communicate with the link partner to determine whether both ends of the links support the power saving features and, if so, which end of the link should be the master that determines the speed of the link. The ‘master’ may then use control frames to instruct the far end MAC to change the speed of the associated PHY. Instead of using direct control of the PHY link speed (which will minimise the time taken to change the link speed) an alternative is to break the link and to control the auto-negotiation registers so that in the next round of auto-negotiation a lower common speed is selected. However, this alternative has the disadvantage of a relatively prolonged interruption of the link.

As is explained further hereinafter, the monitoring of traffic may, and preferably would, be arranged so that downgrading the link bandwidth would not affect overall data throughput of the network. For example, a monitor could snoop on higher level transport protocols to determine a traffic type present on the link as well as the volume of traffic. This enables the building in of ‘intelligence’ so that the link would not be deliberately broken or changed in speed under predetermined circumstances, such as the duration of a telephone call or during the conveyance of important or especially protected information.

Further objects and features of the invention will be apparent from the following description with reference to the accompanying drawings.

### BRIEF DESCRIPTION OF THE DRAWINGS

FIG. 1 illustrates part of a network device including an embodiment of the invention.

FIG. 2 is a flow diagram of a control process executed by the network device in FIG. 1 in accordance with the invention.

FIG. 3 illustrates another embodiment of the invention.

### DETAILED DESCRIPTION

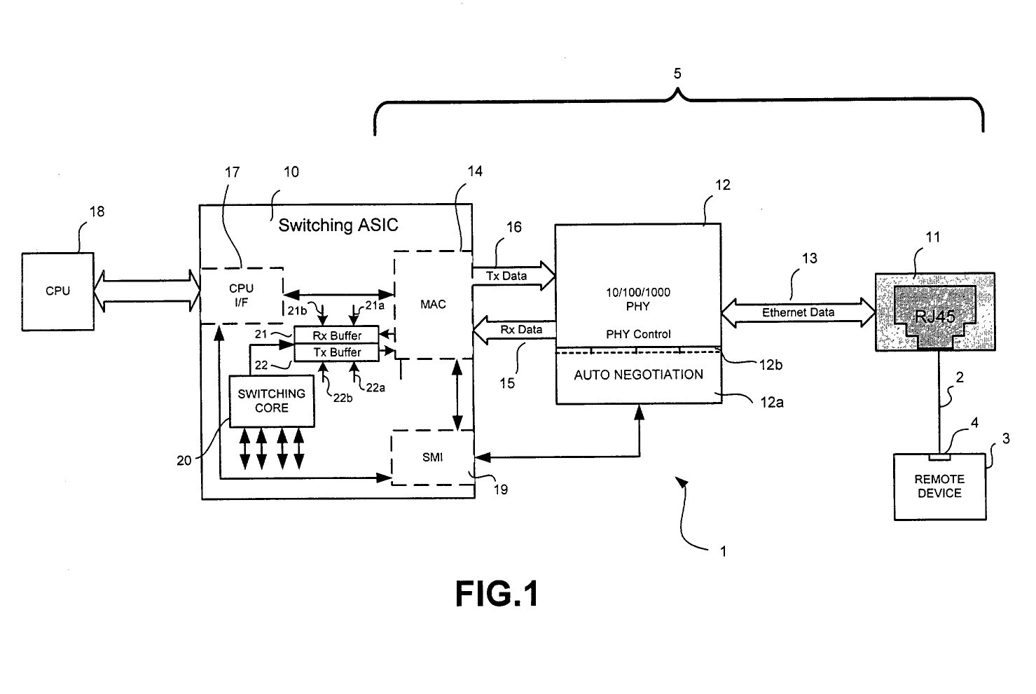

FIG. 1 of the drawings illustrates in simplified form a network device 1 which has a port (more fully described later) which includes a physical connector 11 connected by way of a communication link 2, which may be in general twisted pair, fibre optic or even a wireless link, to a remote device 3 having a relevant port 4 to which the link is connected. However, the invention is primarily intended for use with a ‘twisted pair’ or other link which is normally capable of operation at a multiplicity of data rates.

Physical port connector 11 is typically constituted by an RJ45 connector.

The device 1 is in this embodiment of the invention a network switch having a multiplicity of ports for forwarding and receiving addressed data packets. For the sake of example it will be presumed that the switch, the link 2 and the remote device 3 operate in accordance with an Ethernet system such as IEEE Standard 802.3 (1998 Edition).

One of these ports, a port 5, includes successive components or ‘layers’ constituted by connector 11, a physical layer device (PHY) 12 and a MAC (media access controller) 14.

The PHY 12 is intended to conform to the aforementioned Standard and is capable of operation at a multiplicity of selectable rates, particularly 10 megabits per second, 100 megabits per second and 1000 megabits per second (gigabit operation). The PHY 12 includes an auto-negotiation function 12a which is preferably implemented as a state machine conforming to the aforementioned Standard and particularly clause 28 thereof. The reader is referred to the extensive discussion of auto-negotiation in that section.

The PHY generally is the ‘layer’ between the physically dependent medium, represented by physical connector 11 and link 2 and the medium independent layers, represented by the media access controller 14 in switching ASIC 10. Ethernet data received by physical connector 11 passes to PHY 12 and is converted to a media independent format, denoted Rx Data 15 and proceeds to the media access controller 14 where it is subjected to appropriate preliminary processing and proceeds to (temporary) storage before being forwarded to other port or ports as may be required by the nature of the packet or frame and the address data in it. Correspondingly, data received from within the switching ASIC 10 by the MAC 14 proceeds as Tx Data 16 to the PHY 12 and proceeds onward as Ethernet data to the physical connector 11 and the link 2.

Auto-negotiation as defined in Chapter 28 of the aforementioned Standard is initiated by fast link pulses when a link is established. Then, having recourse to various registers 12b, the PHY device advertises on the link 2 the performance capabilities of the device with respect to the relevant port. The device may have different ports capable of operation in different formats and different data rates. The device may only be capable of operation at lower data rates. In any event, if auto-negotiation is available, there is a forwarding of basic message pages which advertise the performance abilities, particularly the selected data rate or data rates and the duplex mode of which the device is capable on link 2. In an ordinary auto-negotiation exchange, the link partner (remote device 3) returns corresponding messages and there is a negotiation performed by the standardised state machines to determine the common data rate, duplex mode and possibly other performance characteristics for the link 2.

If for example a device 1 is in respect of link 2 capable of operation only at either 10 or 100 megabits per second and device 2 were capable of operation only at 100 and 1000 megabits per second, the auto-negotiation process would select the highest common data rate, namely 100 megabits per second and the auto-negotiation state machines in the link partners would control the relevant PHYs accordingly.

Switching ASIC 10 includes, as represented schematically in FIG. 1, a switching core 20 which as is well known performs the necessary functions by which packets received by MAC 14 are directed in accordance with address data to one or more of the other ports (denoted by the double arrows) of the switch. Where the switching ASIC 10 performs a bridging or routing operation, switching core 20 also includes a look-up facility to determine whether the destination address is in a forwarding database or not. Routers will have recourse to routing tables (not shown). Since the operation of hubs (which do not require any look-up), switches and routers are well known, the functions associated with a switching core will not be described in detail.

It is customary for multi-port devices such as switches and routers to have, for each port, a receive queue, constituting or denoting packets received by the port but not yet subject to operation by the central (switching) core 20 and a transmit queue, consisting or denoting packets which have been subject to operation by the central core 20 and are awaiting transmission from the respective port. Depending on the particular design, the queues may be constituted by the packets, usually each accompanied by a status word, or by pointers each of which indicates the address of a packet in memory. The queues may be formed in FIFOs. In any event buffers 21 and 22 for the queues are provided with two thresholds (21a, 21b and 22a, 22b respectively) indicating a comparatively full state and a comparatively empty state respectively: there is usually space between the upper threshold and a completely full state and between the lower threshold and a completely empty state. In ordinary devices these thresholds are normally employed for controlling the flows of packets across the device, so that for example a ‘full’ transmit queue (as indicated by the upper threshold 22a) may be used to inhibit transfer of packets to that queue from a receive queue of another port.

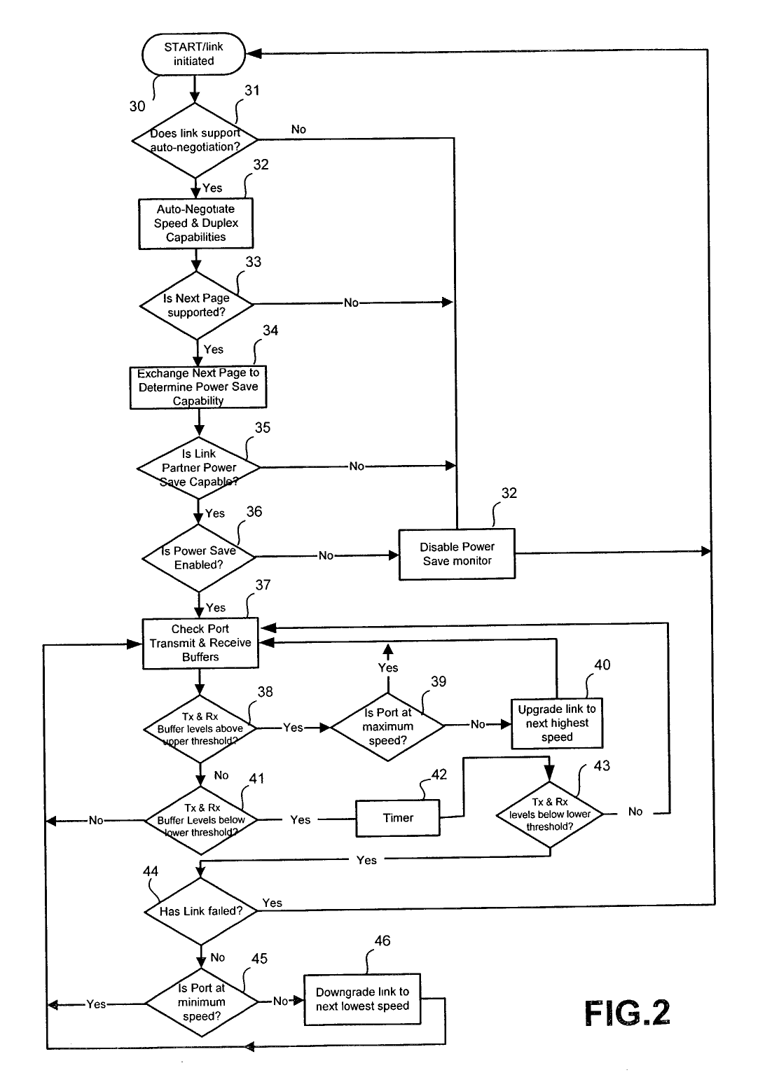

In this embodiment of the invention the buffer thresholds 21a, 21b, 22a and 22b are also employed to provide indications of ‘heavy’ and ‘light’ traffic. The former may be indicated when at least one of the buffers 21 and 22 has a level (i.e. occupancy) above the upper or ‘relatively full’ threshold (21a or 22a); in the process shown in FIG. 2 the indication of heavy traffic depends on relative fullness of both buffers. The indication of ‘light’ traffic may be dependent on a respective level below at least one and preferably both of the ‘relatively empty’ thresholds 21b, 22b and preferably on a repeated occurrence of occupancy levels below these thresholds.

FIG. 2 illustrates the process by which switch 1 and particularly the MAC 14 and the SMI (serial management interface) 19 co-operate with PHY 12 both in the establishment of the link between switch 1 and the remote device 3 and also perform automatic speed change in accordance with the monitoring of traffic flow through the MAC 14. The process may be conducted in hardware or software and implements the traffic monitor and the control of link speed.

Stage 30 represents ‘Link initiated’. This stage may be entered on start-up in response to ‘fast link pulses’ and may be re-entered at appropriate intervals. Stage 31 is a determination whether the link supports auto-negotiation. This stage and the next two stages are well known in themselves and correspond to the normal phases of auto-negotiation in accordance with the aforementioned Standard. If the link supports auto-negotiation then PHY 12 will exchange ordinary auto-negotiation messages with the device at the far end of the link to negotiate the common operating speed and the duplex mode (half-duplex or full-duplex). There will also be a determination, stage 33, whether the ‘Next Page’ function is supported. This is part of the ordinary process of auto-negotiation.

If the link does not support auto-negotiation or as a result from stage 33 the link partners (switch 1 and remote device 3) do not support the Next Page function of auto-negotiation, then the power saving monitor function of the switch will be disabled. In practice an enable signal from the traffic monitor allowing the MAC 14 to instruct the SMI 19 to control PHY 12 will be ‘cleared’.

On the assumption that the ‘Next Page’ function of auto-negotiation is supported, the link partners will exchange ‘Next Pages’ to determine whether each of them has a power save capability. If the link partner (device 3) does not have that capability then the power save monitor will be disabled as before.

If the link partner is ‘power save capable’ there is a determination (stage 36) to discover whether the power save function of device 1 is enabled. It may be disabled for a variety of reasons; for example, during reception and transmission of messages, or of certain types of message as determined by an appropriate filter, there may be an automatic disabling of the power save function.

On the assumption that the power save function is enabled, the transmit and receive buffers 21 and 22 will be checked (stage 37). If the transmit and receive buffer levels are both above the respective upper threshold (indicating heavy traffic) then it will be determined whether the port is at maximum speed, stage 39, and if not the link will be upgraded to the next highest speed, stage 40. e.g. by altering (via the SMI) the PHY control registers 12b in PHY 12.

If the buffer levels are not above the upper threshold there is then a determination, stage 41, whether the transmit and receive buffer levels are each below the respective lower threshold. In order to avoid too rapid switching, the process includes ‘hysteresis’. Thus in the event that both Tx and Rx buffer levels are below the respective lower thresholds, a timer is set (stage 42) and allowed to time out, typically after a comparatively long time such as thirty seconds, before another determination of the buffer thresholds is made. If the levels of the Tx and Rx buffers are still both below the lower thresholds (stage 43) there is a reasonable indication that the traffic is light and that the link may be switched to a lower speed to save power. A preliminary check, stage 44, is made to determine whether the link has failed but provided the link is operating normally stage 45 determines whether the port is at a minimum speed and if not there will be downgrading of the link (stage 46) to the next lowest speed.

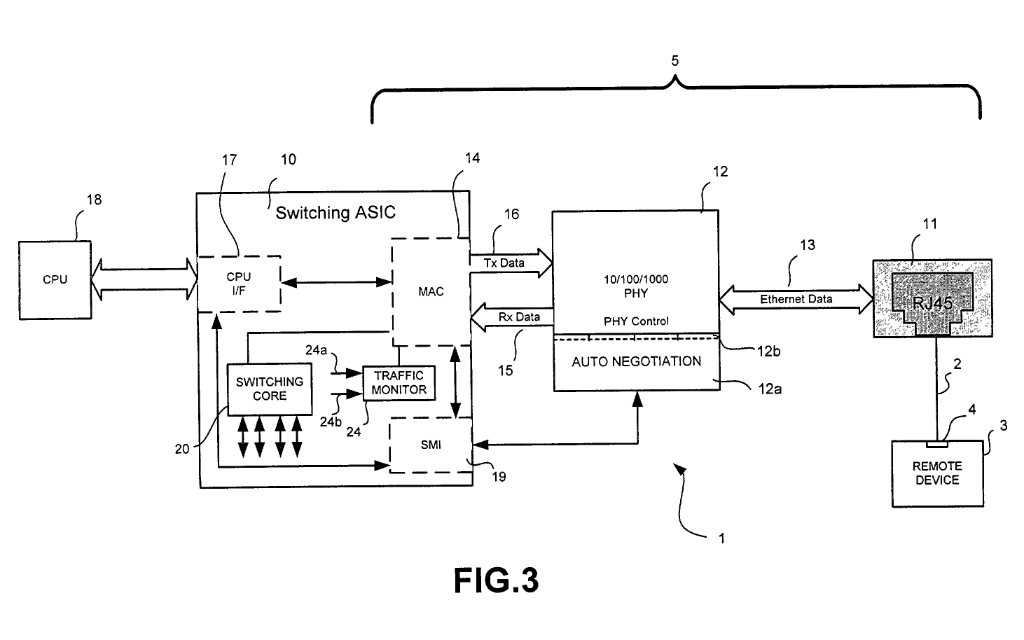

FIG. 3 illustrates an embodiment which is generally similar to that described with reference to FIG. 1. However, instead of using the Tx and Rx buffer thresholds to indicate the volume of traffic, the embodiment shown in FIG. 3 employs a separate traffic monitor 24. This may comprise a counter which is incremented (or decremented) in accordance with packets (or a random selection thereof) passing through the port and which is decremented (or incremented respectively) at some regular rate, i.e. in the manner of a leaky bucket counter. Traffic monitors are well known in the art, and are described in for example U.S. Pat. No. 6,101,554, GB-2316589 and GB-2315967. Leaky bucket counters are also described in for example GB-2336076. In any event, the traffic monitor will obtain a measure of the traffic flow and also will have defined in it an upper threshold, 24a and a lower threshold 24b. The upper threshold will indicate when the traffic is of comparatively high volume and the lower threshold 24b will indicate when the traffic is of comparatively low volume.

Apart from the different manner of obtaining the traffic thresholds, the embodiment shown in FIG. 3 operates as the embodiment shown in FIG. 1 and described with reference to FIG. 2. However, among other possible modifications, the timer stage 42 and second threshold-examination stage 43 could be omitted.

The downgrading of the link to the next lowest speed, as in stage 46 in FIG. 2, may be implemented by a variety of mechanisms. One suitable mechanism is to forward MAC control frames over the link to cause (in known manner) the remote device 3 to change to a lower speed (if possible). Remote device 3 would ascertain whether such a change were possible, send a MAC control frame constituting an acknowledgement in reply, and make the necessary changes to the appropriate registers 12b in the PHY connected to the link 2. On receipt of the acknowledgement PHY 12 would make the predetermined change to the lower speed. A similar process can be employed for the upgrading of the link to the next highest speed, summarised in stage 40 of FIG. 2.

In an alternative scheme, wherein the link is ‘broken’ and the units 1 and 3 re-negotiate, the upgrading and downgrading stages may comprise controlling the PHY 12 to break the link, then adjusting the relevant registers 12b to alter the maximum advertised data rate and to permit the auto-negotiation process to restart.

1. A network device including at least one port which is capable of communication, over a link connecting the port to a remote device, at a multiplicity of selectable data rates and including:
a traffic monitor for monitoring communication traffic through the port and for providing an indication of a relatively large volume of communication traffic through the port and an indication of a relatively low volume of traffic through the port;
a physical layer device which is controllable to provide a selected one of said multiplicity of data rates; and
a control for controlling the physical layer device to cause the selection of a lower data rate when the monitor indicates a relatively low volume of traffic through the port and to cause the selection of a higher data rate when the monitor indicates a relatively high volume of traffic through the port.

2. A network device according to claim 1 wherein the port includes means for auto-negotiating a data rate which is the highest commonly advertised rate for the link and wherein said control alters a previously auto-negotiated data rate.

3. A network device according to claim 1 wherein the port includes means for auto-negotiating a data rate which is the highest commonly advertised rate for the link and wherein said control forces a fresh auto-negotiation with a different maximum advertised data rate for the port.

4. A network device according to claim 1 wherein the traffic monitor includes transmit and receive buffers for the port.

5. A network device according to claim 4 wherein the indication of a relatively high volume of traffic is defined by an upper threshold in at least one of the buffers and the indication of a relatively low volume of traffic is defined by a lower threshold in at least one of the buffers.

6. A network device according to claim 5 wherein the indication of a relatively low volume of traffic comprises a repeated detection of buffer occupancy below lower thresholds in the buffers.

7. A network device including at least one port which is capable of communication, over a link connecting the port to a remote device, at a multiplicity of selectable data rates and including:
a physical layer device which is controllable to provide a selected one of said multiplicity of data rates;
means for auto-negotiating with said remote device one of said data rates;
a traffic monitor for monitoring communication traffic through the port and for providing an indication of a relatively low volume of traffic through the port;
a control for controlling the physical layer device to cause the selection for said link of a second data rate lower than said one rate when the traffic monitor indicates a relatively low volume of traffic through the port

8. A network device according to claim 7 wherein the control alters a previously auto-negotiated data rate.

9. A network device according to claim 7 wherein the control forces a fresh auto-negotiation with a different maximum advertised data rate for the link.

10. A network device according to claim 7 wherein said traffic monitor provides an upper threshold indicating a relatively high volume of traffic and a lower threshold indicating said relatively low volume of traffic through the port and wherein the traffic monitor causes the selection of a higher rate data rate than said second rate when said traffic has said relatively high volume.
